(19) United States
(12) Patent Application Publication
(10) Pub. No.: US 2015/0227586 A1
(43) Pub. Date: Aug. 13, 2015

(54) Methods and Systems for Dynamically Allocating Resources and Tasks Among Database Work Agents in an SMP Environment

(71) Applicant: FutureWei Technologies, Inc., Plano, TX (US)

(72) Inventors: Huaizhi Li, Belmont, CA (US); Qingqing Zhou, Santa Clara, CA (US); Yang Sun, Palo Alto, CA (US)

(73) Assignee: FutureWei Technologies, Inc., Plano, TX (US)

(21) Appl. No.: 14/175,489

(22) Filed: Feb. 7, 2014

(51) Int. Cl. G06F 17/30; G06F 9/50

(52) U.S. Cl. CPC G06F 17/30477; G06F 9/5027

(57) ABSTRACT

Dynamically re-allocating tasks and/or memory quotas amongst work agents in symmetric multiprocessing (SMP) systems can significantly mitigate delays and inefficiencies associated with data skew. For example, unfinished tasks can be reallocated from a busy work agent to an idle work agent upon determining that the idle work agent has finished processing its originally assigned set of tasks. Alternatively, a portion of a memory quota assigned to an idle work agent can be reallocated to a busy work agent for use in processing the remaining tasks. Memory quotas can be re-assigned by releasing the memory quota back into a memory pool once the idle work agent has finished processing its originally assigned tasks, and then reallocating some or all of the memory quota to the busy work agent.

### TECHNICAL FIELD

The present invention relates generally to processing systems, and in particular, to methods and systems for dynamically allocating resources and tasks among database work agents in an SMP environment.

### BACKGROUND

Symmetric multiprocessing (SMP) systems are characterized by two or more work agents (e.g., processors, processing cores, etc.) using shared memory resources to collectively perform processing tasks. SMP systems are commonly used to manage large databases and executing database queries. To execute queries, the SMP system may identify tasks to be processed by the query, and assign different sets of tasks to different work agents for parallel/simultaneous processing. The time required by the work agents to complete their respective sets of tasks may vary considerably due to data skew (e.g., uneven load distribution) as well as other factors (e.g., input/output (I/O), CPU share time, etc.), which results in poor resource utilization and processing delays that can significantly reduce database performance and throughput.

### SUMMARY OF THE INVENTION

Technical advantages are generally achieved, by embodiments of the present invention which describe methods and systems for dynamically allocating resources and tasks among database work agents in an SMP environment.

In accordance with an embodiment, a method for executing queries in a symmetric multiprocessing (SMP) system is provided. In this example, the method comprises identifying tasks to be processed during execution of a query, and allocating the tasks to work agents in a processor. The identified tasks include at least a first set of tasks and a second set of tasks, and the work agents in the processor include at least a first work agent and a second work agent. The first set of tasks is allocated to the first work agent and the second set of tasks is allocated to the second work agent. The method further comprises determining that the first work agent has finished processing the first set of tasks before the second work agent has finished processing the second set of tasks, and re-allocating at least some unfinished tasks in the second set of tasks to the first work agent when a criteria is satisfied. An apparatus for performing this method is also provided.

In accordance with another embodiment, another method for executing queries in a symmetric multiprocessing (SMP) system is provided. In this example, the method comprises identifying tasks to be processed during execution of a query, and assigning memory quotas to work agents of a processor for processing the tasks. The identified tasks include at least a first set of tasks and a second set of tasks, and the work agents in the processor include at least a first work agent and a second work agent. The first work agent is assigned a first memory quota for processing the first set of tasks, and the second work agent is assigned a second memory quota for processing the second set of tasks. The method further includes determining that the first work agent has finished processing the first set of tasks before the second work agent has finished processing the second set of tasks, and re-assigning at least a portion of the first memory quota to the second work agent. An apparatus for performing this method is also provided.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a diagram of an SMP architecture;

FIG. 2 illustrates a diagram of a work flow in a conventional SMP system;

FIGS. 3A-3D illustrates a diagram of a work flow in an embodiment SMP system;

FIG. 4 illustrates a flow chart of an embodiment method for processing queries in an SMP system;

FIG. 5 illustrates a flow chart of another embodiment method for processing queries in an SMP system;

FIG. 6 illustrates a flow chart of an embodiment method for operating an SMP system;

FIG. 7 illustrates a block diagram of an embodiment processing device; and

FIG. 8 illustrates a diagram of an embodiment multi-core central processing unit (CPU) system.

Corresponding numerals and symbols in the different figures generally refer to corresponding parts unless otherwise indicated. The figures are drawn to clearly illustrate the relevant aspects of embodiments of this disclosure and are not necessarily drawn to scale.

### DETAILED DESCRIPTION OF ILLUSTRATIVE EMBODIMENTS

The making and using of disclosed embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

A database is generally pre-apportioned into data partitions, which are assigned to work agents for processing. Different data partitions may include different amounts of data that need to be processed for a given query, which may result in work agents being assigned unequal numbers of tasks for that query (known as data skew). In this disclosure, a “task” corresponds to a uniform amount of data needing to be processed (e.g., scanned, searched, etc.) during query execution. For instance, a task may be defined as a fixed number of database pages that need to be scanned when executing a query. Conventional SMP systems statically assign tasks and memory quotas to work agents during database query processing, meaning that each set of tasks (and each memory quota) remain assigned to the original work agent until all work agents have finished processing their assigned tasks, e.g., until the entire query has been executed. Consequently, conventional SMP systems tend to be highly susceptible to delays attributable to data skew.

Aspects of this disclosure mitigate delays attributable to data skew by dynamically re-allocating tasks and/or memory quotas amongst work agents. In one embodiment, at least some unfinished tasks are reallocated from a busy work agent to an idle work agent upon determining that the idle work agent has finished processing its originally assigned set of tasks. In another embodiment, a portion of a memory quota assigned to the idle work agent is reallocated to the busy work agent for use in processing the remaining tasks. Memory quotas can be re-assigned by releasing the memory quota back into a memory pool once the idle work agent has finished processing its originally assigned tasks, and then reallocating some or all of the memory quota to the busy work agent. In some embodiments, the dynamic re-allocation of processing tasks and memory quotas is performed by a task allocation module (or task allocator). The task allocator may decide to reallocate unfinished tasks when a criteria is satisfied. The criteria may be satisfied when an efficiency gain derived from the re-assignment exceeds a efficiency cost associated with the re-assignment. For example, processing resources may be used to perform the re-assignment, and (in some cases) the involved busy work agents may be interrupted, e.g., may need to pause momentarily to accommodate the re-assignment. In one embodiment, the task allocator is configured to reallocate unfinished tasks from a busy work agent to an idle work agent if a number of unfinished tasks associated with the busy work agent exceeds a threshold. In another embodiment, the task allocator may reallocate unfinished tasks when a percentage of tasks to be reallocated exceeds a threshold. If unfinished tasks are not reallocated to the idle work agent, then the allocation module may reallocate some or all of the idle work agent's memory quota to the busiest work agent(s). These and other aspects of this disclosure are discussed in greater detail below.

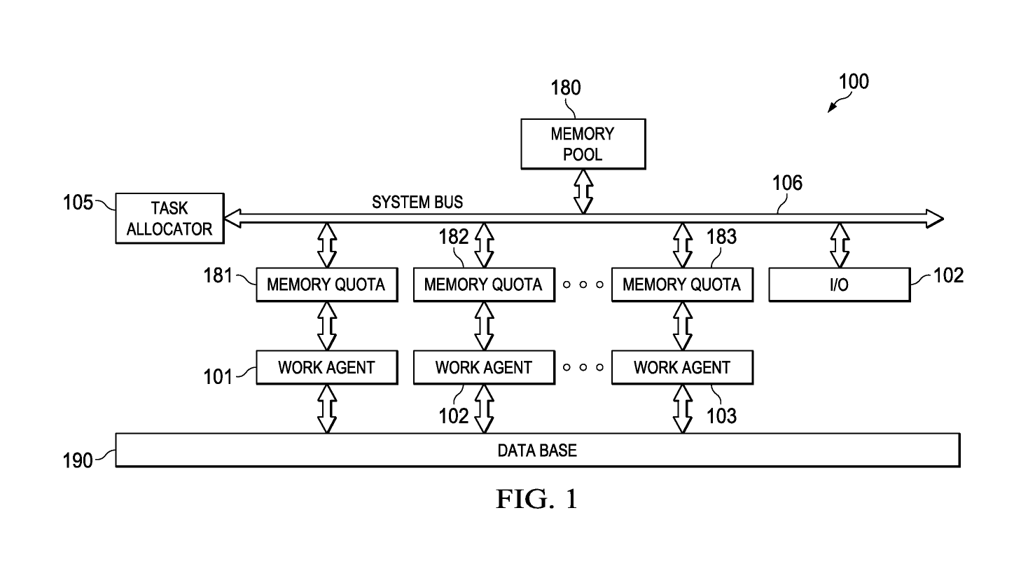

FIG. 1 illustrates an SMP architecture 100 for processing queries. As shown, the SMP architecture 100 comprises a plurality of work agents 101, 102, 103 a task allocator 105, and a memory pool 180, which interact through a system bus 106. The work agents 101, 102, 103 may be any component or collection of components (e.g., CPU cores, etc.) that are configured to process task by accessing (e.g., scanning, searching, etc.) entries of the database 190. The task allocator 105 may be any component or collection of components configured to assign and/or re-assign tasks to the work agents 101, 102, 103. In some embodiments, the task allocator 105 is a specialized thread of the SMP architecture 100. The memory pool 180 includes memory resources that are used by the work agents 101, 102, 103 to process tasks. Shared access to memory resources of the memory pool 180 amongst the work agents 101, 102, 103 may be accomplished through the allocation/assignment of memory quotas. In this example, a memory quota 181 is assigned to the work agent 101, a memory quota 182 is assigned to the work agent 102, and a memory quota 183 is assigned to the work agent 103.

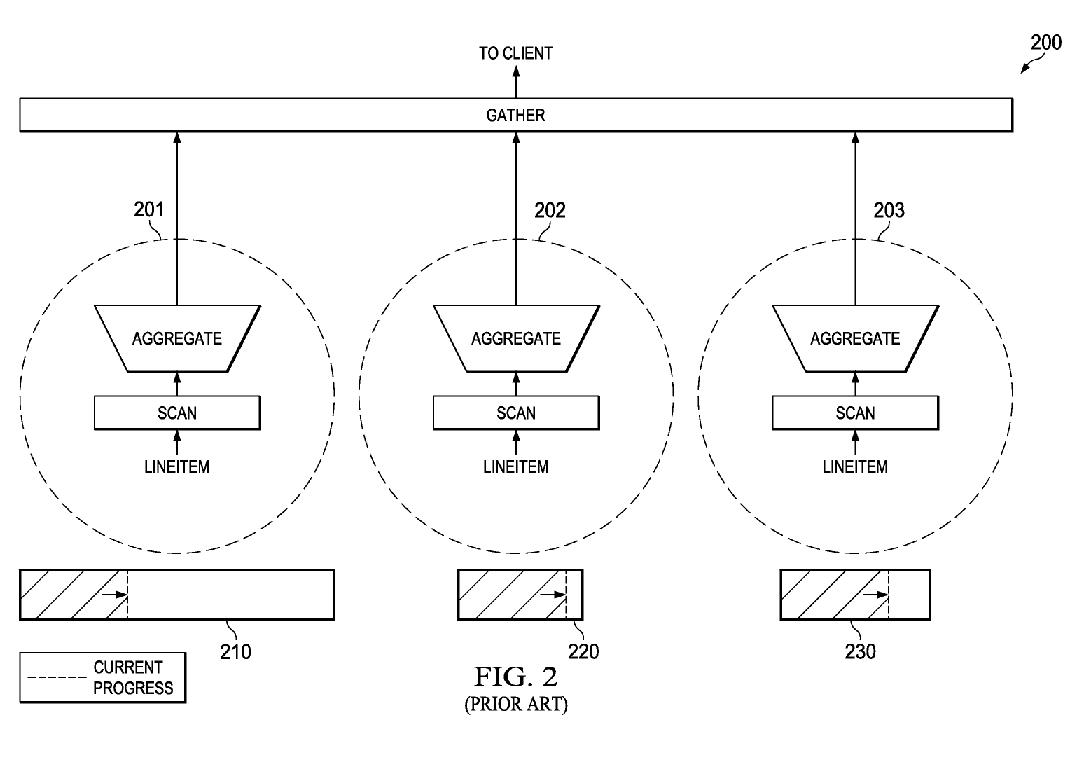

Conventional SMP architectures statically assign processing tasks and memory quotas to work agents. FIG. 2 illustrates a conventional SMP system 200 in which a plurality work agents 201, 202, 203 are statically assigned sets of processing tasks 210, 220, 230. In this example, the conventional SMP system 200 is configured to perform a aggregation operation, where the work agents 201, 202, 203 scan each line item of a processing task, aggregate the results, and send the aggregated results to a gather function, which combines the aggregation results and forwards them to the client. Additionally, the conventional SMP system 200 statically assigns memory quotas to the work agents 201, 202, 203.

Statically assigning tasks/memory-quotas to the work agents 201, 202, 203 (respectively) causes conventional SMP system 200 to be highly susceptible to delays arising from data skew. As an example, it may take the work agent 201 longer to finish processing the set of tasks 210 than it takes the work agents 202, 203 to finish processing the sets of tasks 220, 230 (respectively). In such cases, the work agents 202, 203 (and their statically assigned memory quotas) may remain idle (e.g., unused) while the work agent 201 finishes processing the set of tasks 210, thereby resulting in resource underutilization and reduced efficiency in the conventional SMP system 200.

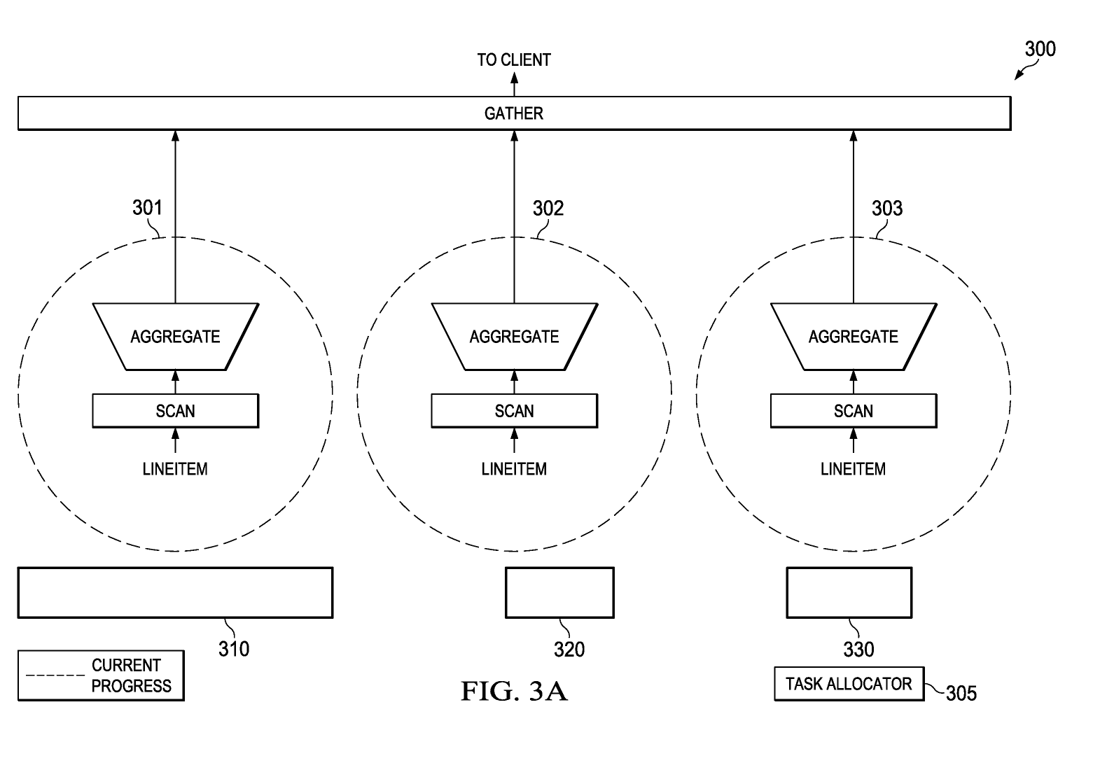

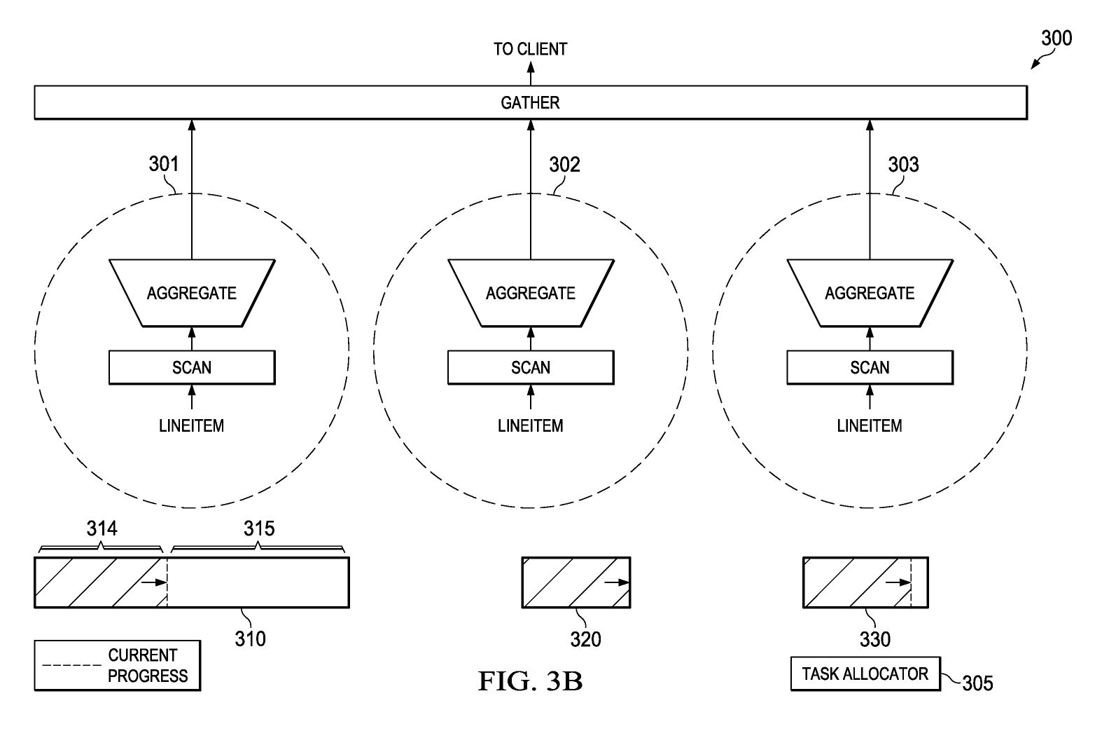

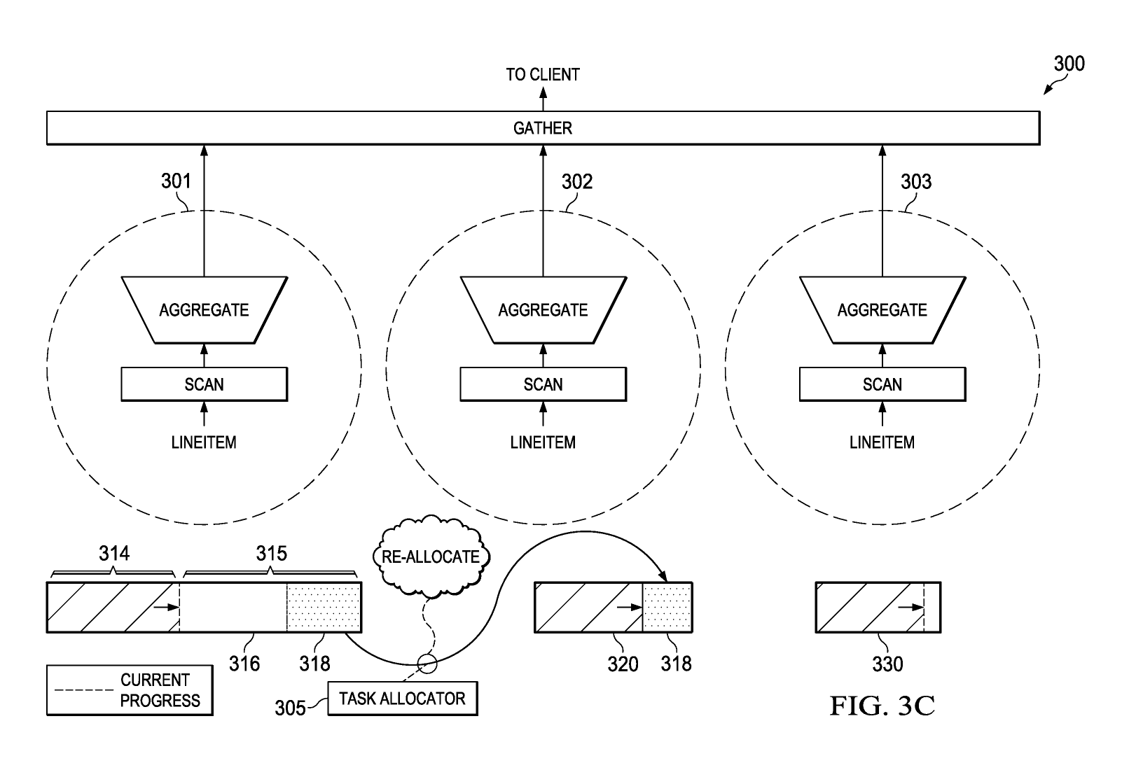

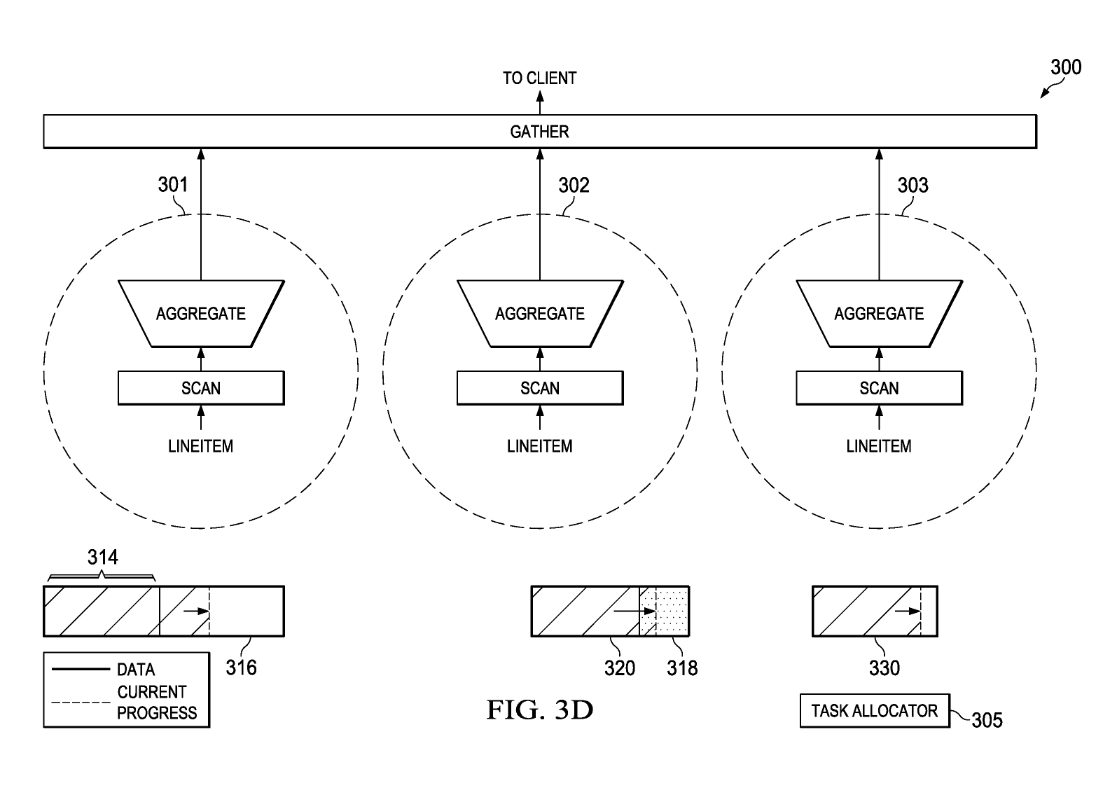

Aspects of this disclosure dynamically reallocate unfinished tasks and/or unused memory quotas to mitigate delays attributable to data skew. FIGS. 3A-3D illustrate an embodiment SMP system 300 configured to reallocate tasks from a busy work agent to an idle work agent. As shown, the SMP system 300 includes a plurality of work agents 301-303, as well as a task allocation module 305. The work agents 301-303 are modules configured to perform parallel processing, while the allocation module 305 is a module configured to reallocate unfinished tasks and/or idle memory quotas amongst the work agents 301-303 to avoid data skew. In some embodiments, the allocation module is a specialized thread. As shown in FIG. 3A, an incoming query is divided into sets of tasks 310, 320, 330, which are assigned to the work agents 301, 302, 303 (respectively) for processing. The sets of tasks 310, 320, 330 may vary in size and complexity. In this example, the set of tasks 310 includes more tasks than the sets of tasks 330, 320. In other examples, each set of tasks may include the same number of processing tasks, but may be processed at different rates by their assigned work agents. After initial task allocation, the work agents 301, 302, 303 begin processing their respective sets of tasks 310, 320, 330 in parallel. The length of time required for the work agents 301, 302, 303 to finish processing their respective set of tasks 310, 320, 330 may vary depending on numerous factors, including the number of tasks in each set and factors effecting the respective processing rates of the work agents, e.g., I/O issues, CPU time share, etc.

As shown in FIG. 3B, the work agent 302 finishes processing the set of tasks 320 before the work agent 301 finishes the set of tasks 310. Notably, at the time in which the work agent 302 goes idle, the work agent 301 has completed a set of finished tasks 314, but has yet to complete a set of unfinished tasks 315. Upon detecting this condition, the task allocation module 305 reallocates some tasks in the set of unfinished tasks 315 to the work agent 302 when a criteria is met, e.g., the number of unfished tasks exceeds a threshold, etc. In this example (as shown in FIG. 3C), the task allocation module 305 reallocates a subset of unfinished tasks 318 to the work agent 302, while a subset of unfinished tasks 316 remains allocated to the work agent 301. Following re-allocation (as shown in FIG. 3D), the work agent 301 processes the subset of unfinished tasks 316, while the work agent 302 processes the reallocated subset of unfinished tasks 318.

In the above-described example, the allocation module 305 reallocated a subset of unfinished tasks 318 to the work agent 302. However, in other examples, the allocation module 305 may allocate at least some unfinished tasks to the work agent 303 as well, since the work agent 303 has almost completed the originally allocated set of tasks 330. In yet other examples, the allocation module 305 may reallocate all or part of a memory quota of the work agent 302 to the work agent 301 after the work agent 302 finishes its tasks.

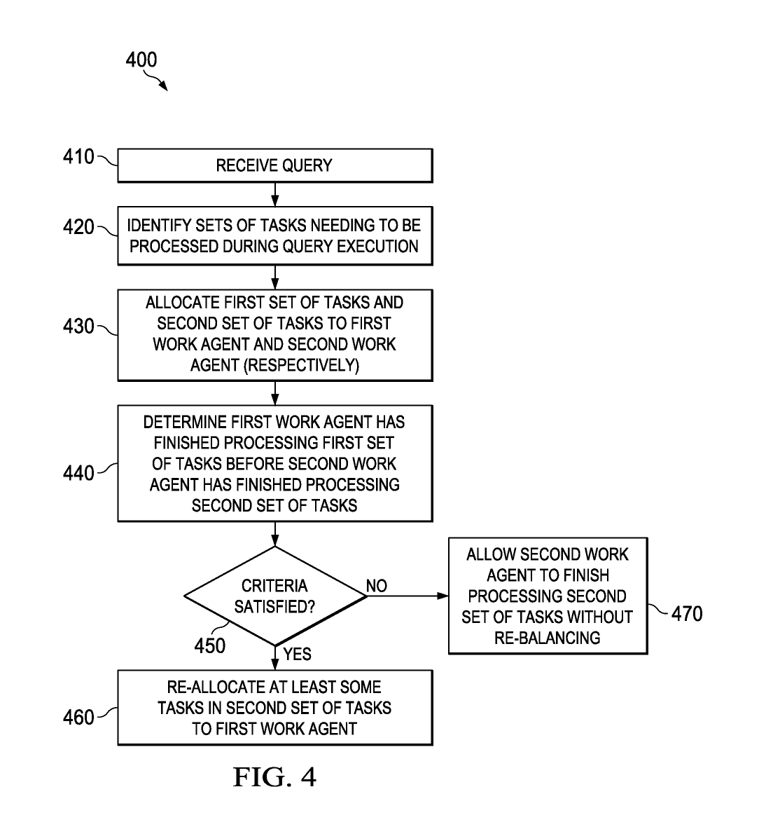

Aspects of this disclosure provide methods for re-allocating unfinished processing tasks to idle work agents in SMP systems. FIG. 4 illustrates a method 400 for processing a query in a SMP system, as may be performed by a processor. As shown, the method 400 begins with step 410, where the processor receives a query. Thereafter, the method 400 proceeds to step 420, where the processor identifies sets of tasks needing to be processed during query execution. This may include identifying which data partitions need to be processed in order to execute the query, and assigning work agents to process the data partitions (or identifying which work agents are pre-assigned to process the identified partitions). Next, the method 400 proceeds to step 430, where the processor allocates a first set of tasks to a first work agent and a second set of tasks to a second work agent. Subsequently, the method 400 proceeds to step 440, where the processor determines that the first work agent has finished processing the first set of tasks before the second work agent has finish processing the second set of tasks. Next, the method 400 proceeds to step 450, where the processor determines whether a criteria is satisfied. In some embodiments, the criteria is satisfied when a number of unfinished tasks in the query (or in the second set of tasks assigned to the second work agent) exceeds a threshold. In another example, the criteria is satisfied when a percentage of tasks needing to be reallocated exceeds a threshold. If the criteria is satisfied, then the method 400 proceeds to step 460, where the processor reallocates at least some tasks in the second set of tasks to the first work agent. If the criteria is not satisfied, the method 400 proceeds to step 470, where the processor allows the second work agent to finish processing the second set of tasks without rebalancing task assignments.

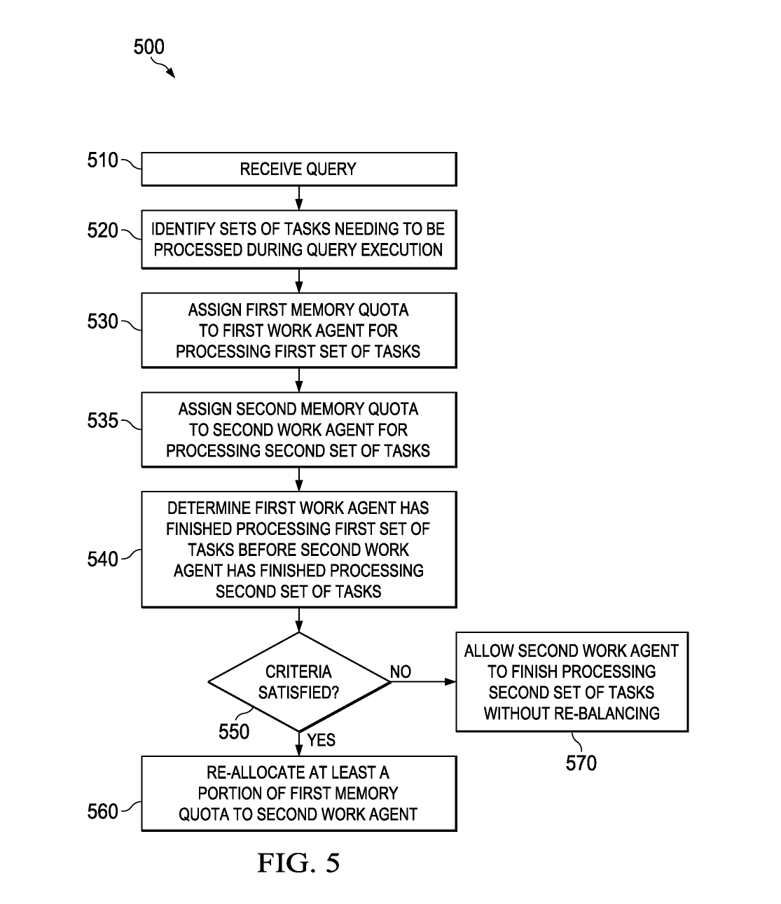

Aspects of this disclosure also provide methods for re-allocating idle or unused memory quotas to busy work agents in SMP systems. FIG. 5 illustrates a method 500 for processing a query in an SMP system, as may be performed by a processor. As shown, the method 500 begins with step 510, where the processor receives a query. Next, the method 500 proceeds to step 520, where the processor identifies sets of tasks needing to be processed during query execution. Thereafter, the method 500 proceeds to step 530, where the processor assigns a first memory quota to a first work agent for the purpose of processing a first set of tasks. Next, the method 500 proceeds to step 535, where the processor assigns a second memory quota to a second work agent for the purpose of processing a second set of tasks. Thereafter, the method 500 proceeds to step 540, where the processor determines that the first work agent has finished processing the first set of tasks before the second work agent has finished processing the second set of tasks. Next, the method 500 proceeds to step 550, where the processor determines whether a criteria has been satisfied. The criteria may be satisfied when a number of unfinished tasks, or a percentage of tasks needing to be reallocated, exceeds a threshold. Alternatively, the criteria may be satisfied when the number of unfinished tasks, or a percentage of tasks needing to be reallocated, fails to exceed a threshold. If the criteria satisfied, then the method 500 proceeds to step 560, where the processor reallocates at least a portion of the first memory quota to the second work agent. In some embodiments, this is achieved by releasing the first memory quota to a memory pool of the SMP system, and then reallocating at least some a portion of the first memory quota to the second work agent. The second work agent then uses the reallocated memory, in addition to the originally allocated second memory quota, to process remaining tasks in the second set of tasks. On the other hand, if the criteria is not satisfied, then the method 500 proceeds to step 570, where the processor allows the second work agent to finish processing the second set of tasks without rebalancing.

Aspects of this disclosure dynamically allocate tasks among work agents by introducing a task allocation module (or task allocator) to the database server instance process. In SMP environments, when a data node instance receives a query, it starts multiple work agents which process the query in parallel. An optimization module (or optimizer) may estimate the number of data rows that each agent processes. The work agents may register their tasks to the task allocator, and periodically report their progress to the task allocator. In some instance, an uneven distribution of tasks among work agents may cause some work agents to complete their set of tasks earlier than other work agents. A configurable threshold value (TASK_ALLOCATION_THRESHOLD) can be defined to determine task allocation. If the remaining job on the busy agents is larger than the TASK_ALLOCATION_THRESHOLD, then the task allocator allocates tasks from the busy agents to the idle agents. The busy agents can split the remaining data into small data blocks, which can be processed separately.

During query execution, agents require memory from the system for query operations, such as hash table builder operations. The amount of memory that an agent can obtain is limited by a configurable quota. Each agent registers its memory quota to the task allocator. During query execution, some work agents finish their job early, in which case, the task allocator can release the quota of those idle agents and increase the memory quota of the busy agents to improve system performance.

An SMP system may have multiple CPU cores, and may launch several work agents upon receiving a query in order to process portions of the query (e.g., sets of tasks) in parallel. Each agent processes its own data partition. The query results are gathered from the work agents and sent to the coordinator, which may return the results to the client. Because of the data skew phenomena, some agents need to process larger data partitions and spend longer time executing the query than other agents. In conventional systems, when a work agent finishes its set of tasks, the CPU cores and memory quota used by the work agent will become idle, thereby causing system resources to be under-utilized. Aspects of this disclosure address this problem by dynamically reassigning unfinished tasks and/or idle memory quota amongst work agents.

During rebalancing, unfinished tasks may be reallocated to idle work agents by the task allocator. In one embodiment, the task allocator may calculate a total number of tasks to be reallocated based on the remaining data pages that still need to be processed by all the busy work agents. This may be determined according to the following formula:

$$tasks\_to \_be \_reallocated = {\sum }_{i = 1}^{n} remaining\_tasks \_on \_agent ( i ) / n ,$$

where n is the number of work agents.

Thereafter, the task allocator may select a busy work agent having the most remaining data pages to be processed as a candidate work agent. The task allocator may then computes a percentage of tasks_to_be_reallocated as the ratio of tasks_to_be_reallocated to the total number of data pages in the partition of this busy work agent using the following formula:

$$percentage of tasks\_to \_be \_reallocated = \frac{tasks\_to \_be \_reallocated}{total number of data pages in the partition}$$

If the percentage of tasks_to_be_reallocated is larger than the TASK_ALLOCATION_THRESHOLD, then the task allocator allocates the task to the free agent.

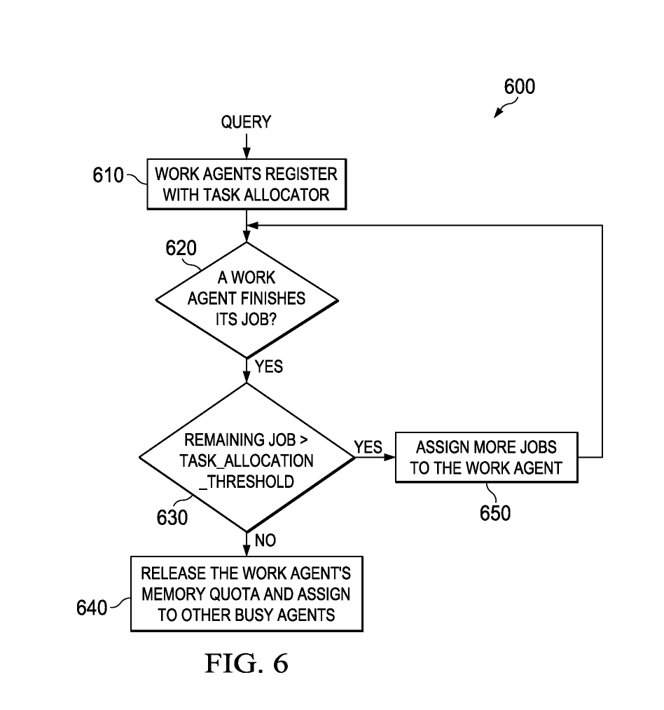

FIG. 6 illustrates a method 600 for processing a query in an SMP system. As shown, the method 600 begins with step 610, where the work agents register their estimated data partition size and memory quota with the task allocator. The work agents may periodically report their progress to the task allocator. Thereafter, the method 600 proceeds to step 620, where the task allocator determines that a work agent has finished his job. Next, the method 600 proceeds to step 630, where the task allocator determines whether remaining jobs/tasks exceed a threshold. The threshold may correspond to a cost of reassignment (e.g., processing resources required to perform the re-assignment). If the remaining jobs/tasks do not exceed the threshold, then the method 600 proceeds 640, where the task allocator releases the idle work agents memory quota to the memory pool, where it can be re-assigned to other busy work agents. If the remaining jobs/tasks exceed the threshold, then the method 600 proceeds 650, where the task allocator assigns more jobs/tasks to the idle work agent. This may include re-allocating tasks from busy work agents to the idle work agent.

Aspects of this disclosure provide a task allocator module to a database instance. The task allocator module can dynamically rebalance query execution tasks and memory allocation among the work agents if the job progress on the work agents is not even. The unevenness of job progress can be caused by data skew or other factors such as I/O. Embodiment re-allocation techniques can enhance the utilization of CPU and memory resources and improve SMP system throughput. The task allocator module can also be used for performance monitoring purpose so that the progress of query execution can be observed. Furthermore, embodiment task allocator modules are light weight and can be implemented as a single thread. Embodiment re-allocation techniques can be applied to various database operations, such as aggregation, sorting, hash-join, merge join, nest loop join, etc. In the context of aggregation, an optimizer module may add final aggregate operators for the parallelization and rebalancing. In the context of hash join, the build side may be shared and the probe phase may be parallelized and rebalanced. In the context of nest loop join operations, a join key may be the partition key for both inner and outer sides, and the outer side can be parallelized and rebalanced. External sorts can be used during sorting and merge join operations,

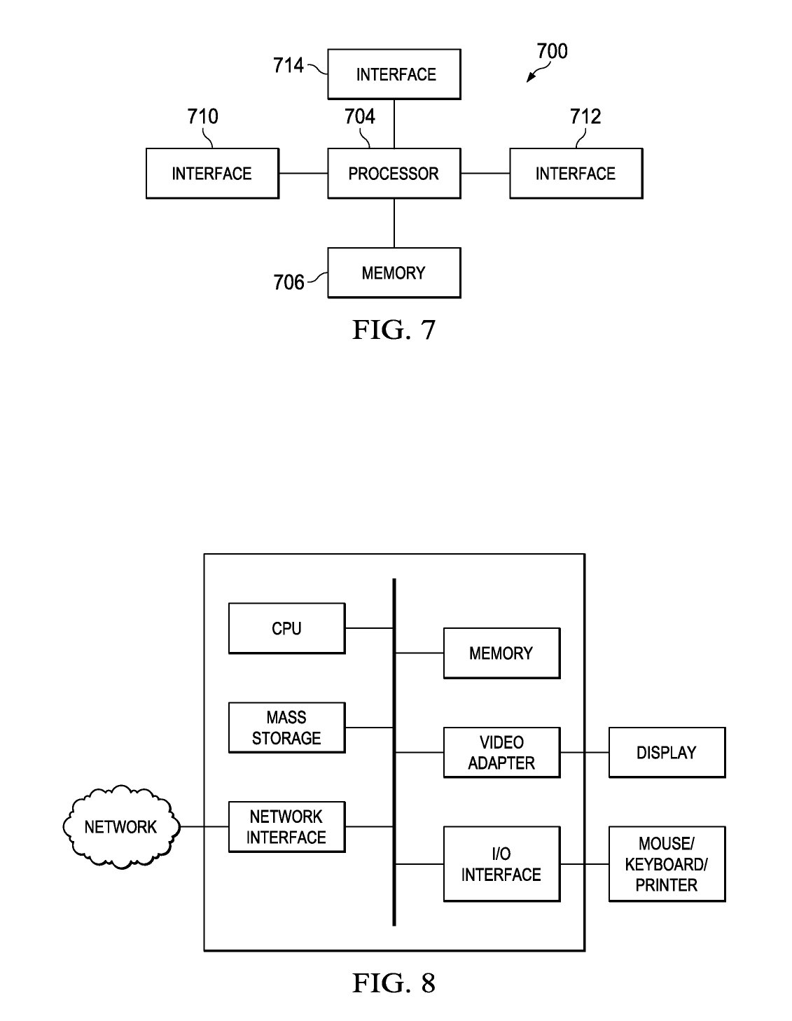

FIG. 7 illustrates a block diagram of an embodiment of processing device 700, which may be equivalent to one or more devices discussed above. The processing device 700 may include a multi-core processor 704, a memory 706, and a plurality of interfaces 710-714, which may (or may not) be arranged as shown in FIG. 7. The multi-core processor 704 may be any component capable of performing computations and/or other processing related tasks, and the memory 706 may be any component capable of storing programming and/or instructions for the multi-core processor 704. The interfaces 710-714 may be any components or collections of components that allow the processing device 700 to communicate with external devices.

FIG. 8 illustrates a block diagram of a multi-core CPU system that may be used for implementing the methods disclosed herein. Embodiment multi-core CPUs systems may utilize all of the components shown, or only a subset of the components, and levels of integration may vary from system to system. Furthermore, a multi-core CPU system may contain multiple instances of a component, such as multiple processing cores, memories, transmitters, receivers, etc. The multi-core CPU may comprise multiple processing cores equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus.

The bus may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface such as Universal Serial Bus (USB) (not shown) may be used to provide an interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A method for executing queries in a symmetric multiprocessing (SMP) system, the method comprising:
identifying, by a processor, tasks to be processed during execution of a query, the tasks including at least a first set of tasks and a second set of tasks, wherein the processor comprises a plurality of work agents including at least a first work agent and a second work agent;
allocating the tasks to the plurality of work agents for processing, wherein the first set of tasks is allocated to the first work agent and the second set of tasks is allocated to the second work agent;
determining that the first work agent has finished processing the first set of tasks before the second work agent has finished processing the second set of tasks; and
re-allocating at least some unfinished tasks in the second set of tasks to the first work agent when a criteria is satisfied.

2. The method of claim 1, wherein the first agent processes the reallocated tasks.

3. The method of claim 1, wherein the criteria is satisfied when a number of unfinished tasks in the second set of tasks exceeds a threshold, the number of unfinished tasks corresponding to tasks in the second set of tasks that have yet to be processed by the second work agent.

4. The method of claim 1, further comprising:
calculating a percentage of tasks to be reallocated, wherein the criteria is satisfied when the percentage of tasks to be reallocated exceeds a threshold.

5. The method of claim 4, wherein calculating the percentage of tasks to be reallocated comprises:
identifying a number of tasks to be reallocated;
calculating a ratio of the number of tasks to be reallocated to a total number of processing tasks associated with the query; and
multiplying the ratio by one hundred.

6. The method of claim 5, wherein identifying the number of tasks to be reallocated comprises:
determining how many tasks have yet to be processed by the plurality of work agents when the first work agent finishes processing the first set of tasks.

7. The method of claim 5, wherein identifying the number of tasks to be reallocated comprises:
calculating the number of tasks to be reallocated in accordance with the following equation: tasks_to_be_reallocated=Σᵢ₌₁ⁿ remaining_tasks_for_agent(i)/n, where remaining_tasks_for_agent(i) is a number of tasks that have yet to be processed by an i^{th} work agent when the first work agent finishes processing the first set of tasks, and n is the total number of work agents in the processor.

8. The method of claim 1, wherein the first work agent is assigned a first memory quota for processing the first set of tasks, and wherein the second work agent is assigned a second memory quota for processing the second set of tasks.

9. The method of claim 8, further comprising:
releasing at least some of the first memory quota to a pool of memory when the criteria is not satisfied.

10. The method of claim 9, further comprising:
re-assigning at least a portion of the first memory quota to the second work agent.

11. The method of claim 10, wherein the second work agent uses the re-assigned portion of the first memory quota to process remaining tasks in the second set of tasks.

12. The method of claim 10, wherein the query includes at least one of an aggregation operation, a sorting operation, a hash join operation, a merge join operation, and a nest loop operation.

13. A processor adapted for symmetric multiprocessing (SMP), the processor comprising:
an interface configured to receive a query, wherein the processor is configured to identify tasks to be processed during execution of the query, the tasks including at least a first set of tasks and a second set of tasks;
a plurality of work agents that include at least a first work agent and a second work agent, wherein the first work agent is assigned to process the first set of tasks, and the second work agent is assigned to process the second set of tasks; and
a task allocation module communicatively coupled to the plurality of work agents, the task allocation module configured to determine that the first work agent has finished processing the first set of tasks before the second work agent has finished processing the second set of tasks, to reallocate at least some tasks in the second set of tasks to the first work agent when a first criteria is satisfied.

14. The processor of claim 13, wherein the task allocation module is further configured to calculate a percentage of tasks to be reallocated after the first work agent has finished processing the first set of tasks, and wherein the criteria is satisfied when the percentage of tasks to be reallocated exceeds a threshold.

15. The processor of claim 13, wherein the task allocation module is one of the plurality of work agents.

16. A method for executing queries in a symmetric multiprocessing (SMP) system, the method comprising:
identifying, by a processor, tasks to be processed during execution of a query, the tasks including at least a first set of tasks and a second set of tasks, wherein the processor comprises a plurality of work agents including at least a first work agent and a second work agent;
assigning memory quotas to the plurality of work agents for processing the tasks, wherein the first work agent is assigned a first memory quota for processing the first set of tasks, and wherein the second work agent is assigned a second memory quota for processing the second set of tasks;
determining that the first work agent has finished processing the first set of tasks before the second work agent has finished processing the second set of tasks; and
re-assigning at least a portion of the first memory quota to the second work agent.

17. The method of claim 16, wherein the second work agent uses the re-assigned portion of the first memory quota to process remaining tasks in the second set of tasks.

18. The method of claim 16, wherein re-assigning at least the portion of the first memory quota to the second work agent comprises:
releasing the first memory quota to a pool of memory after the first work agent finishes processing the first set of tasks;
receiving a memory request from the second work agent; and
re-assigning the portion of the first memory quota to the second work agent in response to the memory request.

19. A processor adapted for symmetric multiprocessing (SMP), the processor comprising:
an interface configured to receive a query, wherein the processor is configured to identify tasks to be processed during execution of the query, the tasks including at least a first set of tasks and a second set of tasks;
a plurality of work agents that include at least a first work agent and a second work agent, wherein the first work agent is assigned to process the first set of tasks using a first memory quota, and the second work agent is assigned to process the second set of tasks using a second memory quota; and
a task allocation module communicatively coupled to the plurality of work agents, the task allocation module configured to determine that the first work agent has finished processing the first set of tasks before the second work agent has finished processing the second set of tasks, to re-assign at least a portion of the first memory quota to the second work agent.

20. The processor of claim 19, wherein the task allocation module is one of the plurality of work agents.
